(19) United States
(12) Patent Application Publication
(10) Pub. No.: US 2025/0004429 A1
(43) Pub. Date: Jan. 2, 2025

(54) METHOD AND SYSTEM FOR OBSERVING A CEMENT KILN PROCESS

(71) Applicant: Innomotics GmbH, 90441 Nürnberg (DE)

(72) Inventors: STEPHAN MERK, München (DE); DIANNA YEE, Vancouver (CA); CHANDRASHEKARA RANGAPURA SHETTAPPA, Bangalore, Karnataka (IN); YUN ZENG, Nürnberg (DE)

(73) Assignee: Innomotics GmbH, 90441 Nürnberg (DE)

(21) Appl. No.: 18/703,617

(22) PCT Filed: Oct. 21, 2022
(86) PCT No.: PCT/EP2022/079409

§ 371 Date: Apr. 22, 2024

(30) Foreign Application Priority Data
Oct. 23, 2021 (IN) 202131048351

(51) Int. Cl. G05B 13/02; G06F 1/20

(52) U.S. Cl. CPC G05B 13/0265; G06F 1/206

(57) ABSTRACT

The current disclosure describes a method of observing a behaviour of a cement kiln process, the method comprising using an artificial intelligence model and forcasting at least one variable based on an artificial intelligence model, wherein the variable depends on the kiln process. Also described is a system for observing a behaviour of a cement kiln process, the system comprising a recording device for data of sensor signals, a model to calculate a forecast of a variable, wherein the variable depends on the kiln process, and in particular a user interface for displaying a forecast of a variable, wherein the variable depends on the kiln process.

### BACKGROUND

The current disclosure relates to a method to observe a behaviour of a cement kiln process. The current disclosure further relates to a system for observing a behaviour of a cement kiln process.

### DESCRIPTION

One of the most challenging tasks in the cement industry is the stabilization of the clinker process in which limestone is burnt to clinker. This process runs in kilns, huge rotating pipes with a heat resistant internal coating, a length of up to 80 meters and a diameter of up to 10 meters. The preheated limestone meal is blown into the kiln, is further heated by the burner of the kiln, melts and between 1200° C. and 1400° C. the relevant chemical reaction producing clinker from CaCO2 takes place. Measuring temperatures at this level is challenging and requires optical measurement devices whose accuracy is limited by the dusty environment inside the kiln. But the kiln sintering zone temperature is a crucial input parameter for controlling the fuel supply for the burner. If the temperature is too high too much NOx forms, which is critical for environmental reasons. If it is too low the kiln clogs, needs to be shut down, cooled down, cleaned and restarted, which takes several days and causes production loss of >500 k € a day. Therefore, to avoid instable system states and unplanned shutdowns, kiln control currently heavily depends on deep expert knowledge and broad experience of the operators in the control room, in particular if alternative fuels like waste, slug or tires are used to reduce OPEX. To make matters worse, the pool of experienced operators is aging and hiring new operators is challenging in developing countries and rural areas, which are the typical locations of cement plants.

The cement kiln process is a complex process being influenced by many parameters. A process control system and more particularly, a process control system for a cement kiln process is needed. A part of the control system might be a system to observe the behaviour of the cement kiln process and in particular to foresee and/or forecast the behaviour of the process.

The current disclosure describes methods accordingly to claim 1, and a system for observing a behaviour of a cement kiln process according to claim 12. Further embodiments are also described in claims 2 to 11, 13 and 14.

Accordingly, the current disclosure describes a method for observing a behaviour of a cement kiln process the method comprising: using an artificial intelligence model and forecasting at least one variable based on an artificial intelligence model, wherein the variable depends on the kiln process. So, the current disclosure relates also to process control systems and more particularly, to a system for a cement kiln process. The method can in an example address the problem of kiln control and unplanned kiln shutdowns due to thermochemically instable kiln states. This can be achieved by training forecast models for critical kiln parameters like the sintering zone temperature or the kiln main drive current and an automatic anomaly detection which gives an operator hints about trends towards kiln instability.

In an example the artificial intelligence system is based on machine learning. Up to now the kiln control and forecasting is mainly solved by the human factor, i. e. operators with deep expert knowledge who based on their many years' experience can gauge the process state by monitoring the various process parameters or real-time videos from the interior of the kiln.

In an example a model predictive control is use and/or a kiln simulation is used based on physical models of the kiln process which calculate set points.

In an example the forecasted (predicted) variable, based on the artificial intelligence model, is a critical kiln dependent variable, wherein the variable is in particular based on a sintering zone temperature, a kiln main drive current, a tertiary air temperature, a kiln inlet pressure and/or a kiln inlet temperature.

In an example machine learning (ML) is used for forecasting critical kiln dependent variables like the sintering zone temperature, the kiln main drive current, the tertiary air temperature, the kiln inlet pressure and the kiln inlet temperature. These variables are not directly controlled but are important indicators for the stability of the kiln process and are impacted by the controlled variables like the fuels burnt in the calciner/kiln, the kiln rotation speed or the ID fan rotation speed. Therefore, kiln operators are highly interested to get forecasts for these 5 variables to assess to stability of the kiln process in the near future (e. g. 15-30 minutes).

In an example at least five variables are forecasted, which are critical kiln dependent variables, wherein the five variables are based on a sintering zone temperature, a kiln main drive current, a tertiary air temperature, a kiln inlet pressure and a kiln inlet temperature, wherein in particular the forecast includes in addition at least one of the following variables which are based on data related to: kiln Main Drive Current, kiln RPM, kiln inlet temperature, kiln inlet pressure, kiln inlet NOx, calciner outlet pressure, calciner outlet temperature, calciner O2, calciner CO, sintering zone temperature, pre heater fan RPM, pre heater outlet O2, pre heater outlet CO, tertiary air temperature, main Burner Coal and/or NH3 consumption.

In an example the variable is impacted by a controlled variable, wherein the controlled variable is in particular related to the fuels burnt in the kiln, the kiln rotation speed and/or the ID fan rotation speed.

In an example a window statistic is built, like a mean, max or min of at least one of the at least one variable which is forecasted, wherein the window is in particular of 10 to 40 minutes length. So at least one of a variety of forecast models predict a window statistic like the mean, max or min of one of the 5 respective variables above over a window of 15- or 30-minutes length (forecast horizon).

In an example the artificial intelligence model is trained on historical data from a historian of a kiln control system, wherein the data include at least one of the following sensor signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner.

In an example the artificial intelligence model is trained on historical data from a historian of a kiln control system, wherein the data include at least ten, in particular all, of the following sensor signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner.

In an example the artificial intelligence model is trained on historical data from a historian of a kiln control system, wherein for controlling the Burning Zone Temperature following process parameter are read: Kiln Torque, NOX, BZT Temp, Kiln Feed, main burner coal, Calciner coal, O2. Therefore, the following set points are controlled: Kiln Coal Set point and PC Coal set point.

In an example the artificial intelligence model is trained on historical data from a historian of a kiln control system, wherein for controlling the kiln feed following process parameter are read: O2, BZT Temp, Kiln Torque, Liter Weight. Therefore, the Kiln Feed Set point is controlled.

In an example the artificial intelligence model is trained on historical data from a historian of a kiln control system, wherein for controlling the kiln speed following process parameter are read: Kiln Speed, BZT Temp, Kiln Filling, Kiln Torque, Total Kiln Feed. Therefore, the Kiln VFD Set point is controlled.

In an example at least a variety of the sensor signals have a resolution of at least 60 seconds.

In an example the resolution of different sensor signals can be adjusted differently, in particular between 1 to 60 seconds.

In an example an accuracy of the forecast is calculated.

Accordingly, the current disclosure describes also a system for observing a behaviour of a cement kiln process, the system comprising: a recording device for data of sensor signals, wherein the sensor signals are related to at least one of the following signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner, a model to calculate a forecast of a variable, wherein the variable depends on the kiln process, and in particular a user interface for displaying a forecast of a variable, wherein the variable depends on the kiln process.

In an example the forecast model or a variety of forecast models are trained on historical data (e.g. data over 5 months) from the historian of the kiln control system, which typically includes the following sensor signals or a subset in a resolution of at least 60 seconds:
Kiln main drive current
Kiln rotation speed
Kiln feed
ID fan rotation speed
Kiln inlet pressure
Calciner head pressure
Kiln inlet temperature
Calciner head temperature
Sintering zone temperature
Tertiary air temperature
Carbon monoxide before filter
Oxygen before filter
NOx at kiln inlet
Oxygen at kiln inlet
Main burner coal feed
Main burner refuse-derived-fuel feed
Main burner gas consumption
Calciner coal feed
Calciner refuse-derived-fuel feed
Kiln satellite burner feed
Urea consumption
Oxygen after calciner
Carbon monoxide after calciner

In an example different models are stored. So, the best model can be selected for prediction (forecasting).

In an example the system is arranged to perform a method as described.

Compared to a kiln process operation that relies on operators with deep expert knowledge the described methods and systems can show in particular a variety of advantages:
Like a classical automation solution, it works also if no operators with deep expert knowledge are available (e.g. in developing countries where cement plants have to be shut down due to operator errors for up to 150 days a year);
Reduced cost for operators and their training:
Increased up time and therefore less production loss due to unplanned shutdowns in case of instable kiln states and/or
Improved automation in monitoring quality of cement manufacturing with contextual alarms which are derived from using the forecast values and actual sensor values, i. e, less reliance on constant human monitoring.

While MPC based solutions calculate setpoints, that are automatically applied, which makes it a black-box solution, the here described methods and systems make it possible to e.g. calculate forecasts which are displayed to the operator. This helps operators to build up trust in the reliability of the solution and allows them for the final decision. In addition, MPC based solutions require high engineering effort and therefore cost, while the here described methods and systems learns from data.

In an example the method includes an anomalous detection of a kiln state.

In an example the method includes an anomaly warning based on AI, wherein the warning can be displayed to an operator.

The following detailed description references the drawings showing further examples, wherein:

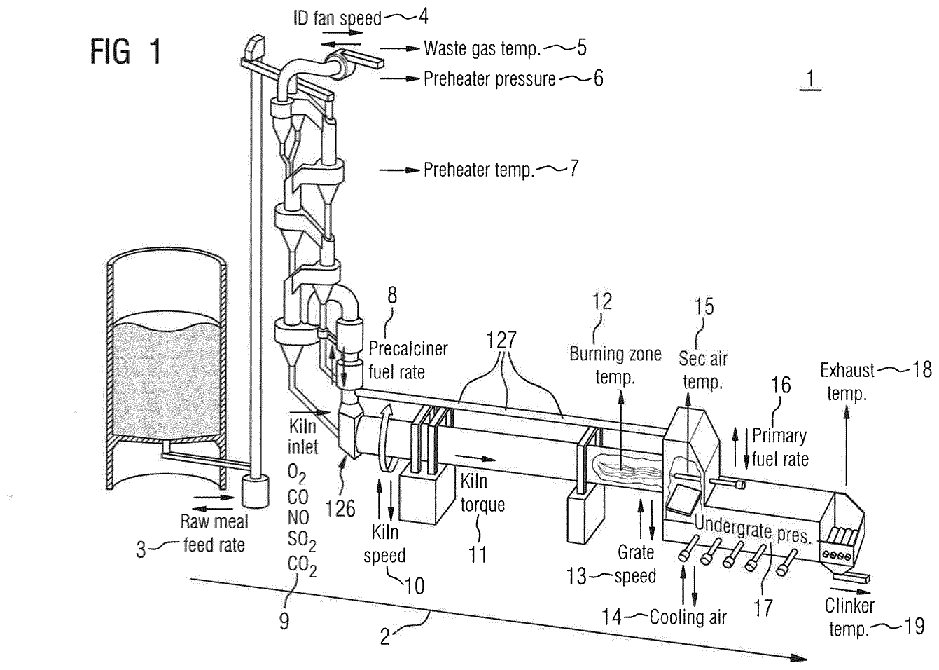

FIG. 1 illustrates a kiln system;

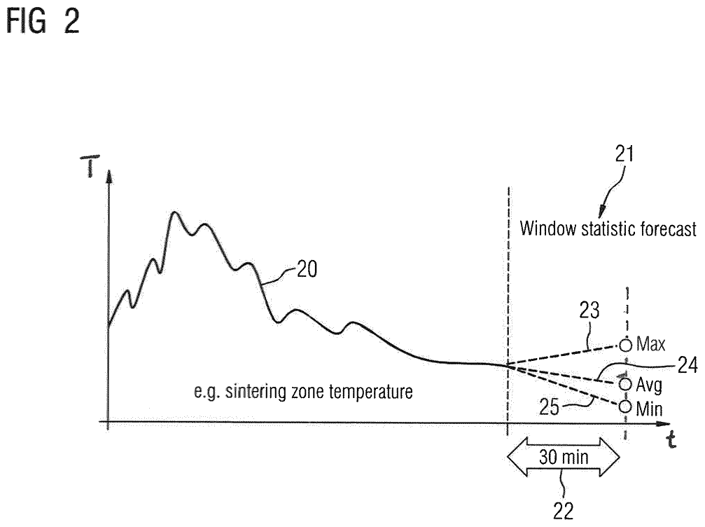

FIG. 2 illustrates a forecast for a target variable;

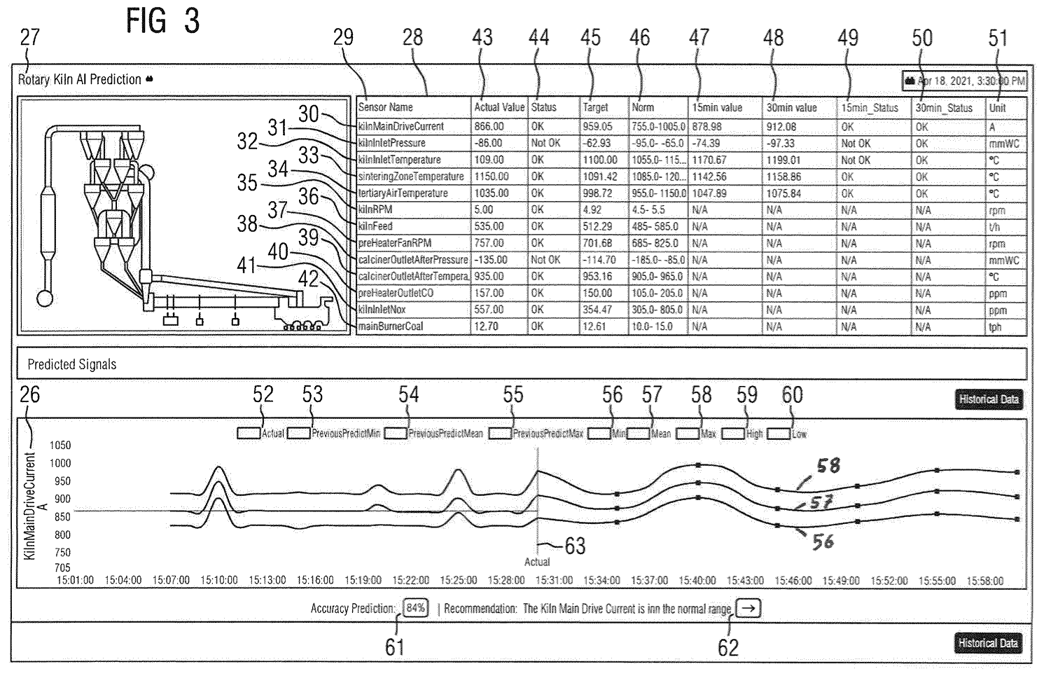

FIG. 3 illustrates a forecast of the main drive current as a target variable;

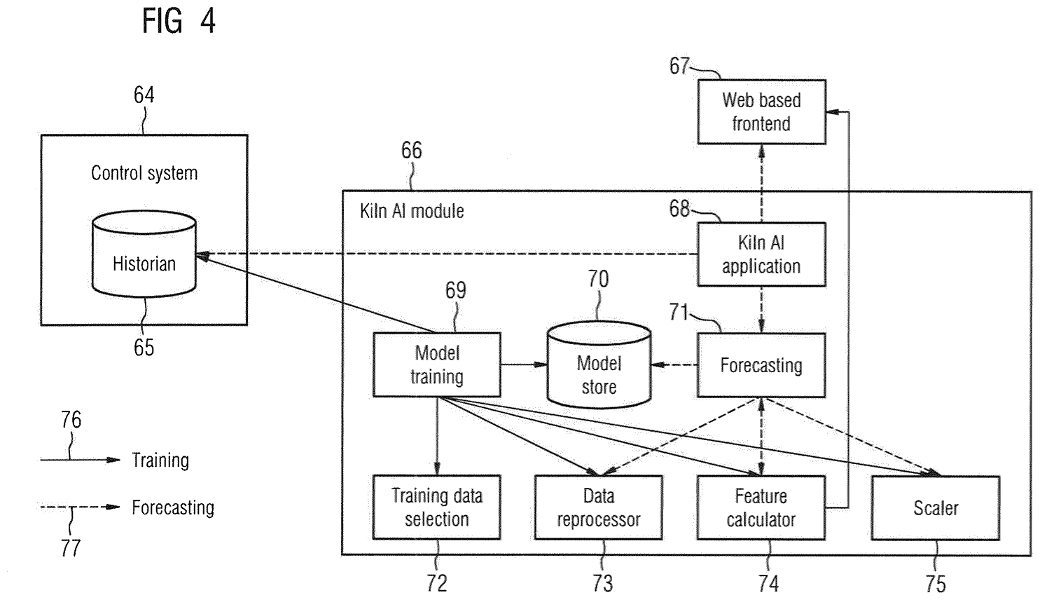

FIG. 4 illustrates an overview of the AI system;

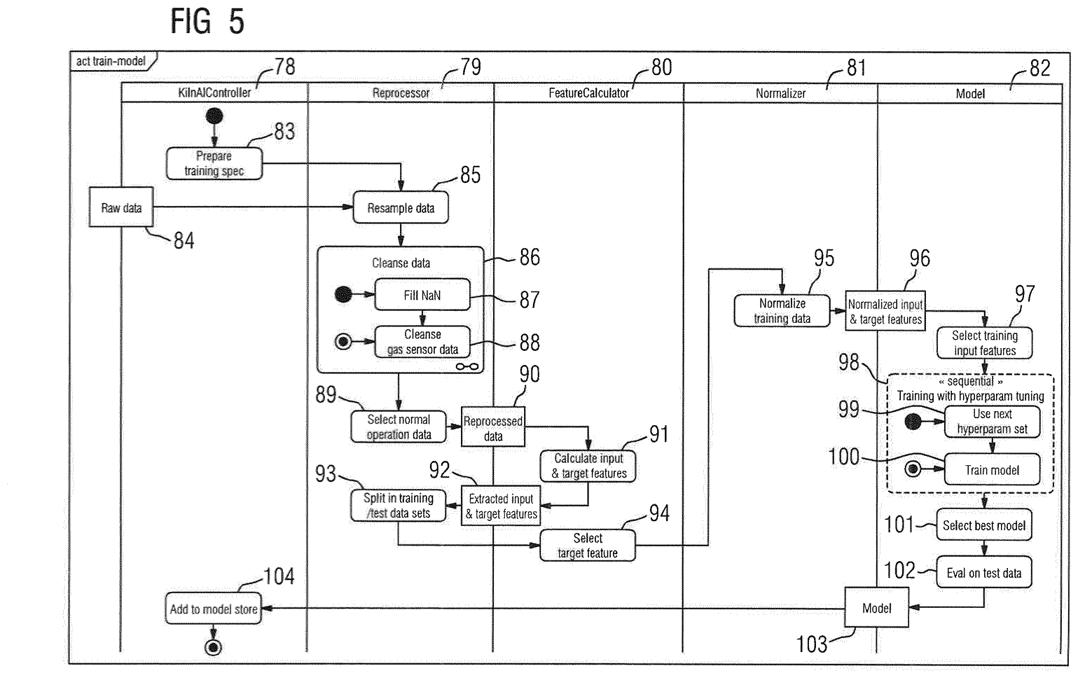

FIG. 5 illustrates a training of a model and

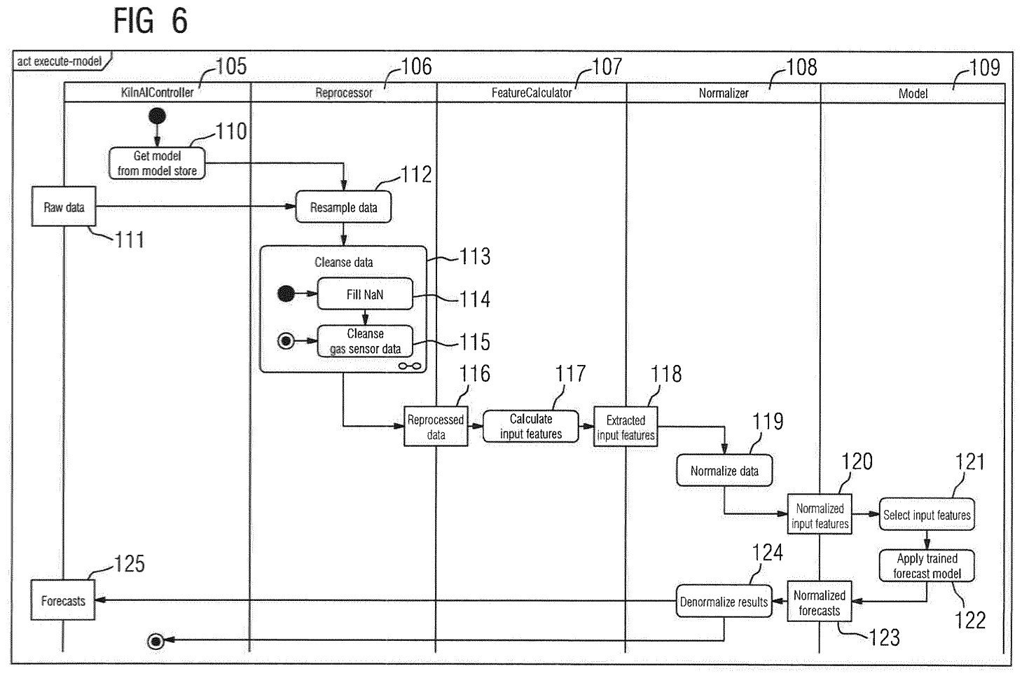

FIG. 6 illustrates an execution of the model.

FIG. 1 shows an overview of a kiln system 1 to perform a kiln process 2. The following elements, features and/or data are shown in detail: a raw meal feed rate 3, a ID fan speed (ID: Induced Draft) 4, a waste gas temperature 5, a preheater pressure 6, a preheater temperature 7, a precalciner fuel rate 8, a kiln inlet (O2, CO, NO, S02, C02) 9, a kiln speed 10, a kiln torque 11, a burning zone temperature (sintering zone temperature) 12, a grate speed 13, a cooling air 14, secondary air temperature 15, a primary fuel rate 16, a undergrate pressure 17, an exhaust temperature 18, a clinker temperature 19, a kiln feed 126 and a tertiary air temperature 127.

FIG. 2 illustrates a forecast for a target variable. The target value is for example a sintering zone temperature 20. The temperature T is plotted against time t in the diagram of FIG. 2. A window statistic forecast 21 is shown. For a period 22 of 30 minutes a maximum 23, a minimum 25 and an average 24 is shown for the target variable. For each target variable the forecasts can be presented to an operator, e.g. using a chart shown in FIG. 2. Possible extensions to such a chart are for example (not displayed in FIG. 2):
Display bars with the optimal range for the respective variable und/or
Graphical highlighting of the forecast (e.g. by changed colors, blinking) of the forecast leaves the optimal range

Based on the forecasting described above subsequent anomaly detection can be done as follows:
Check whether actual values for a target variable leave the expected forecasted range of values for a certain amount of time
Check whether for a set of target variables the actual values leave the respective forecasted range of values for a certain amount of time.
Check whether the forecasted target variable (s) and/or actual ranges are out of the recommended optimal range for system operation.
Check whether the forecasted target variable (s) and/or actual ranges are close to being out of the recommended optimal range for system operation.

Different forecasting charts of various values, which are based on AI, can be displayed to an operator similar to FIG. 2.

FIG. 3 illustrates a forecast of a kiln main drive current 26 as a target variable. Displayed is a rotary kiln AI prediction screen shot 27. A list 28 of the following sensor names 29 is shown: Kiln main drive current 30, Kiln inlet pressure 31, Kiln inlet temperature 32, Sintering zone temperature 33, Teriary air temperature 34, Kiln rpm 35, Kiln feed 36, pre heater fan rpm 37, Calciner outlet after pressure 38, Calciner outlet after temperature 39, Pre heater outlet CO 40, Kiln inlet NOx 41 and main burner coal 42. For these sensors the following data are shown in the list 28: actual value 43, status 44, target 45, norm 46, 15 minutes value 47, 30 minutes value 48, 15 minutes status 49, 30 minutes status 50 and Unit 51. For the main drive current 26, as a predicted (forecasted) signal, the following data are shown by using curves: Actual 52, Previous predicted minimum 53, Previous predicted mean 54, Previous predicted maximum 55, Min 56, Mean 57, Max 58, High 59 and Low 60. On the left side of actual values 63 the past is displayed and on the right of the actual values 63 the forecast is shown. What is also displayed is an accuracy prediction 61 and a recommendation (e.g. the kiln main drive current is in the normal range) 62.

FIG. 4 illustrates an overview of the AI system. The main functionality of the system can be bases on the following components: a control system 64 having Historian data 65, a Kiln AI module 66 and a web-based frontend 67. The Kiln AI module 66 comprises the following components: Kiln AI application 68, Model training 69, Model store 70, Forecasting 71, Training data selection 72, Data preprocessor 73, Feature calculator 74 and a scaler 75. Also shown is a data flow for training 76 and forecasting 77. The control system component 64 with historian 65 provides process data from clinker process. The model training component 69 uses process data from historian orchestrates data preprocessing. It is also used for at least one of the following: feature calculation, scaling of calculated features and actual training together with storing trained models and their metadata in a model store. The component training data selection 72 selects periods of normal operation from input data that are used for training. The component data preprocessor 73 preprocesses data, e.g. by filling NaNs (neuronal networks) or applying filters. The feature calculator 74 calculates features like window statistics, lagged values and/or lagged window statistics from pre-processed data. The scaler 75 scales input features to a common range. The model store 70 allows for storing and retrieving models by their ID or metadata (e.g. used training data, model performance on test data). The Forecasting component 71 uses process data from historian and models from the model store, orchestrates data preprocessing, performs feature calculation and scaling of calculated features and application of the model (models). The kiln AI application 68 runs forecasts, detects anomalies and processes them for presentation. The web-based frontend 67 presents process data, forecasts and anomaly warning to the user.

FIG. 5 illustrates a training of a model. For training the models the raw data from the historian is preprocessed and suitable features are calculated from the preprocessed data. An example for a general procedure is shown in this Figure.

The preprocessing of the data for training includes the following steps:
Data imputation (e.g. by forward/backward filling of short periods with missing values);
Filtering of sensor signals, in particular data from sensors (e.g. gas sensors) that are measured with a different frequency. This is done with well-known approaches like low-pass or high-pass filters;
Selection of periods with normal operation that shall be included in training.

A selection of periods with normal operation can be done, e.g. by:
Labeling the data by a human expert using a suitable labeling tool, wherein for example the following labels can be used for the kiln process:
   Normal operation
   Upnormal operation
   Kiln shut down
   Kiln start up
   Kiln warning;
Rule based selection of normal operation;
Probabilistic models that use statistical distributions together with assumptions about the distribution of normal operation.

In feature calculation a set of features that are relevant to the kiln process are calculated form the preprocessed data. Examples of such features are:
Lagged values of the input parameters (e.g. variable X 30, 60, 120, 180 minutes ago);
Window statistics from the past (e.g. aggregation of variable X over windows of 5, 10, 15, 60 minutes in the past using aggregations like the mean, standard deviation, kurtosis, skew, min, max);
Lagged window statistics from the past (e.g. aggregation of variable X over windows of 5, 10, 15, 60 minutes ending at various times in the past using aggregations like the mean, standard deviation, kurtosis, skew, min, max);
Calculations on several input variables using physical formula and
Calculation of transformations on time series data like Fourier transforms, Wavelet transforms or convolutions.

These calculated features together with the target window statistics are then used for training forecast models like linear models (lasso regression) and non-linear models such as neural network models. Such forecast models have an automatic feature selection design (for example, with weight regularization) where input features with higher predictive power will be weighted more for predicting the target variables while input features with lower predictive power will be neglected.

As the data in the cement manufacturing process can be highly noisy, one can take measures to ensure robustness in the trained models. One approach is to use an ensemble of models to reduce prediction instability.

An example of training the forecast model can be based on:
1. A model is first fitted and the magnitude of the weights are interpreted to select features to keep as part of the input;
2. Using the subset of selected input features which are used to train the final ensemble model and/or
3. The final forecast model is the averaged prediction of an ensemble of models.

For neural networks, one can proceed in a similar fashion, and additionally use architectural design such as batch normalization layers and residual/skip connections.

In general, it is possible to train separate single-output models for each individual combination of target variable (variables from the first paragraph of this section) aggregation (min, max, mean) and forecast horizon (e.g. 15 minutes, 30 minutes) or to train so called multi-output for all targets or a subset of targets.

FIG. 5 illustrates an actual training of a model using a flow chart. The steps are placed in functional columns, which are: Kiln AI controller 78, Preprocessor 79, Feature calculator 80, Normalizer 81 and Model 82. The flow charts comprises the following steps and functions: Prepare training specification 83, provide raw data 84, Resample data 85, Cleanse training data (including fill NaN (neuronal network) 87, cleanse gas sensor data 88) 86, Select normal operation data 89, provide reprocessed data 90, Calculate input and target features 91, Extracted input and target features 92, Split in training/test data sets 93, Select target features 94, Normalize training data 95, Normalized input and target features 96, Select training input features 97, Sequential training with hyperparameter tuning (use nest hyperparameter set 99 and train model 100) 98, Select best model 101, Evaluation on test data 102, shape model 103 and add model to model store 104.

FIG. 6 illustrates an execution of the model. Model application/forecasting is for example done on live data from the control system and requires enough data, e.g. from the last 3 hours of operation. This data is preprocessed, and features are calculated in the same way as in model training. Then the calculated features are fed to the trained model (s) which outputs a forecast for each combination of target variable (variables from the first paragraph of this section) aggregation (min, max, mean) and forecast horizon (e.g. 15 minutes, 30 minutes).

Similar to FIG. 5 the steps for execution of the model are placed in functional columns, which are: Kiln AI controller 105, Preprocessor 106, Feature calculator 107, Normalizer 108, Model 109. The flow charts comprise the following steps and functions: Get model from model store 110, provide raw data 111, Resample data 112, Cleanse data (including fill NaN 114 and cleanse gas sensor data 115) 113, provide reprocessed data 116, Calculate features 117, provide extracted input features 118, Normalize data 119, provide normalized input features 120, Select input features 121, Apply trained forecast model 122, Normalized forecast 123, Denormalize results 124 and provide forecasts 125.

1.-14. (canceled)

15. A method for observing a behaviour of a cement kiln process, the method comprising:
using an artificial intelligence model; and
forecasting a variable based on an artificial intelligence model, wherein the variable depends on the kiln process.

16. The method according to claim 15, wherein the artificial intelligence is based on machine learning.

17. The method according to claim 15, wherein the variable is a critical kiln dependent variable.

18. The method according to claim 17, wherein the critical kiln dependent variable is based on a sintering zone temperature, a kiln main drive current, a tertiary air temperature, a kiln inlet pressure and/or a kiln inlet temperature.

19. The method according to claim 15, comprising forecasting at least five of said variable which are critical kiln dependent variables, wherein the five variables are based on a sintering zone temperature, a kiln main drive current, a tertiary air temperature, a kiln inlet pressure and a kiln inlet temperature.

20. The method according to claim 19, wherein the forecasting of the at least five variables includes at least one of the following variables which are based on data related to: kiln Main Drive Current, kiln RDM, kiln inlet temperature, kiln inlet pressure, kiln inlet NOx, calciner outlet pressure, calciner outlet temperature, calciner O2, calciner CO, sintering zone temperature, pre heater fan RPM, pre heater outlet O2, pre heater outlet CO, tertiary air temperature, main Burner Coal and/or NH3 consumption.

21. The method according to claim 15, wherein the variable is impacted by a controlled variable.

22. The method according to claim 21, wherein the controlled variable is related to a fuel burnt in the kiln, a kiln rotation speed and/or an ID fan rotation speed.

23. The method according to claim 15, further comprising building a window statistic, including a mean, max or min of the variable which is forecasted.

24. The method according to claim 23, wherein the window is of 10 to 40 minutes length.

25. The method according to claim 15, further comprising training the artificial intelligence model on historical data from a historian of a kiln control system, wherein the historical data include at least one of the following sensor signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner.

26. The method according to claim 15, further comprising training the artificial intelligence model on historical data from a historian of a kiln control system, wherein the historical data include at least ten of the following sensor signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner.

27. The method according to claim 26, wherein the historical data includes all of the sensor signals.

28. The method according to claim 26, wherein at least a variety of the sensor signals have a resolution of at least 60 seconds.

29. The method according to claim 26, wherein a resolution of different ones of the sensor signals is adjustable differently.

30. The method according to claim 29, in wherein the resolution of the different ones of the sensor signals is adjustable between 1 to 60 seconds.

31. The method according to claim 15, further comprising calculating an accuracy of the forecasting.

32. A system for observing a behaviour of a cement kiln process, the system comprising:
a recording device for data of sensor signals, wherein the sensor signals are related to at least one of the following signals: kiln main drive current, kiln rotation speed, kiln feed, ID fan rotation speed, kiln inlet pressure, calciner head pressure, kiln inlet temperature, calciner head temperature, sintering zone temperature, tertiary air temperature, carbon monoxide before filter, oxygen before filter, NOx at kiln inlet, oxygen at kiln inlet, main burner coal feed, main burner refuse-derived-fuel feed, main burner gas consumption, calciner coal feed, calciner refuse-derived-fuel feed, kiln satellite burner feed, urea consumption, oxygen after calciner and/or carbon monoxide after calciner;
a model designed to calculate a forecast of a variable, wherein the variable depends on the kiln process; and
a user interface designed to display the forecast of the variable.

33. The system according to claim 32, wherein different models are stored.

34. The system according to claim 32, wherein the system is arranged to perform a method as set forth in claim 15.
